(19) United States
(12) Patent Application Publication
(10) Pub. No.: US 2007/0107011 A1
(43) Pub. Date: May 10, 2007

(54) System and method for differentiated service levels in an internet protocol television network

(76) Inventors: Zhi Li, San Ramon, CA (US); Raghvendra G. Savoor, Walnut Creek, CA (US); Canhui Ou, Danville, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/271,198

(22) Filed: Nov. 10, 2005

(51) Int. Cl. H04N 7/10; G06F 13/00; H04N 7/025; G06F 3/00; H04N 5/445

(52) U.S. Cl. 725/34; 725/42; 725/35

(57) ABSTRACT

Various embodiments of the inventive subject matter provide a framework that may be used to provide service level differentiation in an IPTV delivery system based on program content for any given television channel or programming. For example, for the same TV channel, different service levels may be offered and provided, with each level of service offering to individual subscribers. For example, in one embodiment service levels may be provided by varying the number and duration of commercials or the amount of display space afforded to commercials, value-added content and/or entertainment content in a particular channel. Accordingly, the systems and methods hereof allow service providers flexibility to provide IPTV advertisement and value-added content services. This service differentiation can be used to attract different levels of subscribers, increasing the penetration ratio of IPTV services, facilitate the delivery of effective advertisements to target subscribers, and/or increase revenue. In some cases, some subscribers will pay more money to watch TV with fewer ads and more value-added content. Other subscribers may be agreeable to watching more ads if they can receive TV for less money. Thus, providing customized live TV delivery service is may enable IPTV providers to improve penetration ratio and increase revenue.

### TECHNICAL FIELD

The inventive subject matter relates to the field of television distribution and programming, and more particularly to methods and systems including content-based service differentiation

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2005, SBC Knowledge Ventures L.P. All Rights Reserved.

### BACKGROUND

Internet protocol television (IPTV) service is an alternative way to provide live TV programs to subscribers. In IPTV, TV programs may be transmitted on top of IP-based multicast. Similarly to traditional forms of broadcast television, for each TV channel, there is only one set of video stream content being broadcasted through the IPTV network. Also, similar to cable and satellite television delivery systems, the pricing for IPTV services is typically related to the number of channels and video quality, such as standard, digital or high definition TV programs.

### SUMMARY OF THE INVENTION

Various embodiments of the inventive subject matter hereof provides system, method, and data structure for service level differentiation in an IPTV network.

### BRIEF DESCRIPTION OF THE DRAWINGS

FIGS. 1, 2, 3 illustrate an IPTV network in accordance with one example embodiment of the inventive subject matter hereof;

FIGS. 4A, 4B and 4C illustrate an example of various display configurations using spatial-based service differentiation according to one embodiment of the inventive subject matter hereof;

FIG. 5 illustrates a flow chart of a method for locating servers according to one example embodiment of the inventive subject matter hereof;

FIGS. 6 and 7 illustrate methods of service level differentiation according to still another example embodiment of the inventive subject matter hereof; and

FIG. 8 illustrates still another example embodiment of a system and method for service level differentiation.

### DETAILED DESCRIPTION

In the following detailed description, reference is made to the accompanying drawings that form a part hereof, and in which are shown by way of illustration specific embodiments in which the inventive subject matter can be practiced. It is understood that other embodiments may be utilized and structural changes may be made without departing from the scope of the present invention. The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

As described further below, according to the various embodiments of the inventive subject matter described herein, there is provided a framework that may be used to provide service level differentiation in an IPTV delivery system based on program content for any given television channel or programming. For example, for the same TV channel, different service levels may be offered and provided, with each level of service offering to individual subscribers. For example, in one embodiment service levels may be provided by varying the number and duration of commercials or the amount of display space afforded to commercials, value-added content and/or entertainment content in a particular channel.

Accordingly, the systems and methods hereof allow service providers flexibility to provide IPTV advertisement and value-added content services. This service differentiation can be used to attract different levels of subscribers, increasing the penetration ratio of IPTV services, facilitate the delivery of effective advertisements to target subscribers, and/or increase revenue. In some cases, some subscribers will pay more money to watch TV with fewer ads and more value-added content. Other subscribers may be agreeable to watching more ads if they can receive TV for less money. Thus, providing customized live TV delivery service is may enable IPTV providers to improve penetration ratio and increase revenue.

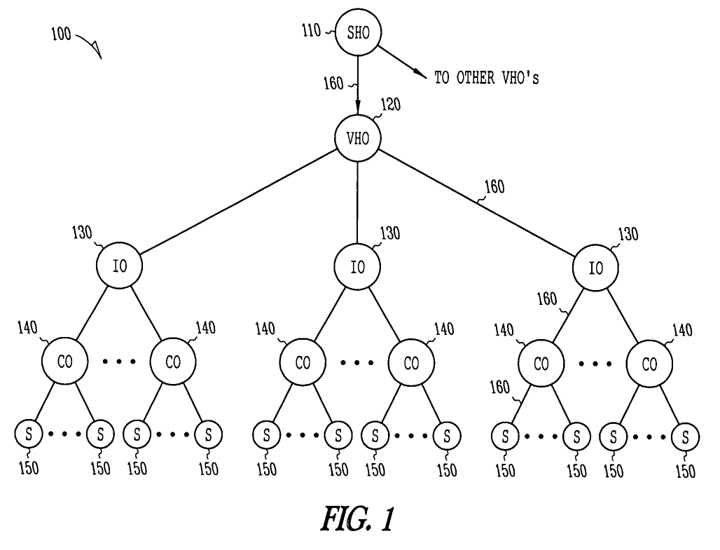

Referring now to FIGS. 1, 2 and 3, there is illustrated schematic diagrams depicting a configuration of an IPTV network 100 in accordance with one embodiment of the inventive subject matter hereof. As shown in FIG. 1, the network 100 includes a super hub office (SHO) 120 for acquisition and encoding of video content, one or more video hub offices (VHO) 120 in each demographic market area (DMA), one or more intermediate offices (IO) 130, one or more central offices (CO) 140 located in each metropolitan area, and finally the subscribers (S) 150, which may be located in single or multiple dwelling units. In one example embodiment, the network 100 may be connected through a plurality of high speed communication links 160 using physical transport layers such as fiber, cable, twisted pair, air or other media.

In one example embodiment, of the IPTV video delivery system, the SHO 110 distributes content to the VHOs 120 which may be spread across the a wide geographic territory, such as an entire country. The SHO 110 may, for example, be in a central location for acquisition and aggregation of national-level broadcast TV (or linear) programming. A redundant SHO 110 may be provided for backup in case of failure. The SHO 110 may also the central point of on-demand content acquisition and insertion into the IPTV network. Linear programming may be received at the SHO 110 via satellite and processed for delivery to the VHOs 120. On-demand content may be received from various sources and processed/encoded to codec and bit-rate requirements for the communication network for transmission to the VHOs 120 over the high speed communication links. VHOs 120 are the video distribution points within each demographic market area (DMA) or geographic region.

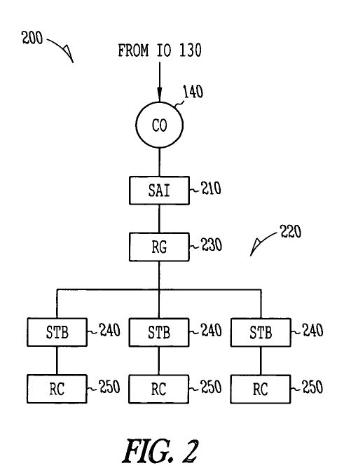

Referring now to FIG. 2, there is illustrated in more detail an example network architecture 200 between the CO 140 and the subscriber 150. A serving area interface (SAI) 210 is connected to the CO 140. SAI 210 may, for example, be located in a weather-proof enclosure proximate the subscriber premises, and may include FTTN equipment. FTTN equipment may also be located in the CO 140. Customer premise equipment includes (CPE) 220, for example, a network interface device (NID) and a residential gateway (RG) 230, for example with a built-in VDSL modem or optical network termination (ONT). In both cases the RG 230 may be connected to the rest of the home set top boxes (STBs) 230 via an internal network such as an Ethernet. Each STB 240 has an associated remote control (RC) 250 which provides data entry to the STB 240 to control the IPTV selections from the IPTV data streams.

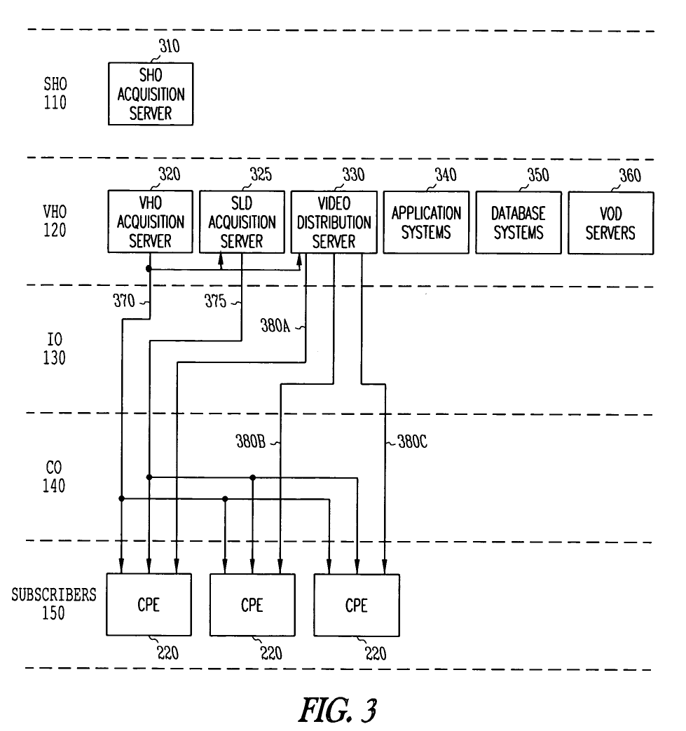

Referring now to FIG. 3, which illustrates one example embodiment of a configuration according to the inventive subject matter, a SHO acquisition server 310 may be used to acquire national content that may be distributed towards the VHOs 120. In an alternative embodiment, live television content may be acquired using an acquisition server in the VHOs 120. In this configuration, the VHO 120 may include a live television acquisition server 320 and a video distribution server 330, which forward the live television and/or other content toward the subscriber through the intermediate offices (IOs) 130 and the central office (CO) 140. A VHO 120 may include also include application systems 340, regional subscriber database systems 350, and VOD servers 360. The COs 140 are connected to the IOs 130 to further distribute traffic towards the subscribers 150. Traffic may reach the subscribers 150 at least partially via either fiber to the node (FTTN) or fiber to the premises (FTTP), or by other types of transmission medium.

As also illustrated in FIG. 3, acquisition server 320 distributes a plurality of live television programs, each typically associated with a television “channel,” using a multicast IP protocol data stream 370 through the IOs 130 and COs 140 to the subscribers 140. The routers, switches and other network elements that would normally be present in the IOs 130 and COs 140 are not shown in FIG. 3 in order to simplify the drawing. The number of programs or channels sent in the multicast stream may, without limitation, range up to 800 channels or more using present technology with it being understood that advances in technology may allow many more channels to be sent. The multicast protocol allows for efficient distribution of these signals to a large number of end subscribers. In addition, the video distribution server 330 receives the multicast data stream 370 and distributes selected ones of the live television signals, extracted from the stream 370, using a unicast data stream 380a, 380b and 380c, to specific subscribers 150. In this embodiment, video distribution server 330 may provide a unicast stream, for example in burst mode, of a specific live television channel to any of the subscribers served by the VHO 120. The burst mode instant channel change data stream can be discontinued once the subscriber's system is loaded with enough TV program data so that the multicast stream can “catch up” and take over supplying the program data stream in the multicast mode for more extended term viewing by the subscriber.

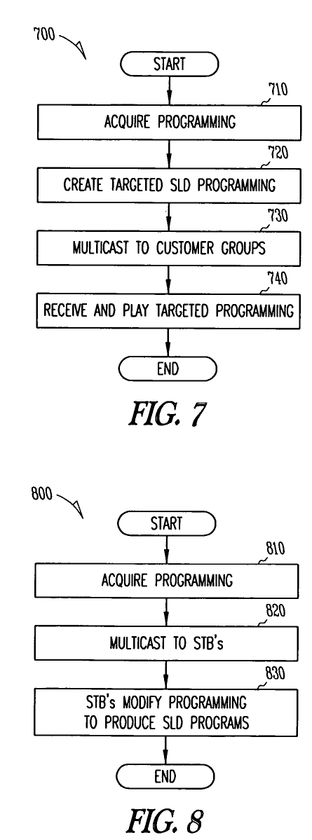

Also provided in the VHO 120, or alternatively at another distribution point in the IPTV network such as the SHO 110, IO 130 or CO 140, is an additional service level differentiated (SLD) acquisition server 325 that acquires live television programming, creates service level differentiated variants of one or more channels of programming being distributed by server 320, and distributes the alternate SLD channels to subscribers using a multicast data stream 375 in the same manner as server 320. Alternatively, in another embodiment, the functions described for SLD acquisition server 325 may be performed by a single acquisition server such as server 320, and server 325 can be eliminated. The subscribers 150 may thus be enabled to obtain either the conventional channels produced in multicast data stream 370, or one or more corresponding SLD channels produced in multicast data stream 375. According to one embodiment, as described further below, a subscriber may pay more to access an SLD channel with fewer advertisements, or less if restricted to viewing only SLD channels that include more advertisements than a normal television channel. The access to “regular” or SLD channels may be controlled by a set top box device in the subscriber premises, as described more fully below. Thus, in one example embodiment, each subscriber 150 receives live television programs from the video acquisition server 320 or 325 based on IP-based multicasting services, while the video distribution servers 330 are used to provide subscribers “instant” channel change and recover video packet losses to maintain acceptable quality of service. As described more fully below with respect to FIG. 8, in accordance with an alternate example embodiment, the normal channel and the advertising and/or value-added service can be delivered via separate channels and combined together at the STB 240.

As noted above, live IPTV streams are usually delivered based on the IP multicast protocol. The full range of multicast addresses is from 324.0.0.0 to 339.255.255.255. That is, the number multicast streams on top of the Internet can be 16*255*255*255. This provides service providers enough flexibility to deliver different levels of video content for the same TV channel to a large number of subscribers. Further, as the TV streams are delivered based on IP multicast, the backbone traffic increase will at most be (L−1)*N*B irrespective the number of subscribers (except subscriber-specific content), where L is the number of service levels, N is the number of channels which we provide service differentiation and B is the per-stream bandwidth consumption.

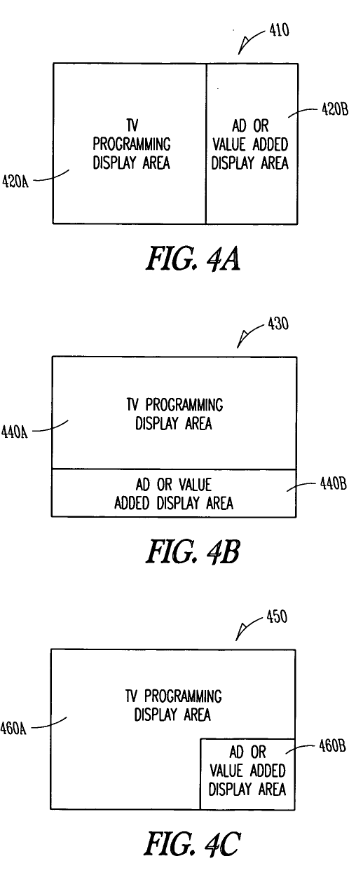

According to one example embodiment of the inventive subject matter hereof, content-based service level differentiation may be provided using time-based differentiation, spaced-based differentiation, or combinations of the two. In time-based differentiation, for example, conventional TV ads are replaced with different types of value-added content during the normal commercial breaks in programming, or in between regularly scheduled programming. For example, but not by way of limitation, instead of normal advertising in the programming, the SLD programming may provide value-added content during the time ads are normally run. In space-based service level differentiations, the normal television ads (or interactive ads or value-added content) are provided in the TV programming in the format of picture-in-picture (PIP), or otherwise in a spatial sense as opposed to a temporal sense. The size and the duration of such PIP-based ads (or value-added content) may also varied for different levels of subscribers. Examples of PIP-based ads 400 are illustrated in FIGS. 4A, 4B and 4C. A first PIP configuration 410 includes an area 420a to display programming content and an area 420b to display advertising content. A second PIP configuration 430 includes an area 440a to display programming content and an area 440b to display advertising content. A third PIP configuration 450 includes an area 460a to display programming content and an area 460b to display advertising content. In still another embodiment, time-based differentiation and space-based differentiation may be combined.

Based on the above-described content service differentiation techniques, different levels of content services can be provided, for example time-based ads service only, lower priced service with space-based ads, and premium priced services providing value added content during normal time-based advertising time slots. The “normal” time-based ad service is the same as normal TV program delivery, as is conventionally provided on network television broadcasts supported by advertising revenue. In one embodiment, the subscribers are not entitled to receive value-added content in this level of service. In another example embodiment, there is provided a lower price service with space-based ads. The lower price service is subsidized by the addition of more ads in the television programming using space-based ads. Accordingly, in addition to the normal TV advertisements run during commercial breaks, this service also inserts more advertising programs and content using the PIP-based method or otherwise, for example as shown in FIGS. 4A, 4B and 4C. The added advertising content may be normal ads or interactive ads. Such ads may be billboard style without an audio stream if displayed at the same time as the normal programming, or if displayed simultaneously with normal time-based advertising. Using this lower price service, subscribers may pay little or no fee to gain access to the television programming.

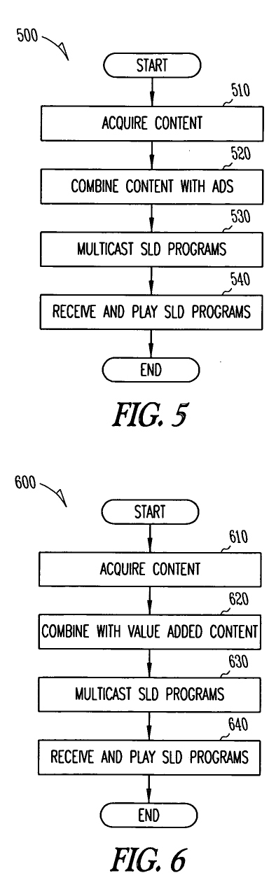

As shown in FIG. 5, this service may be provided according to the example embodiment of method 500, wherein normal programming is acquired 510, and further wherein the programming includes time-based advertising inserted for example by a national or local provider in the broadcast network. The normal programming is then combined 520 with space-based advertising using server 325, to provide an alternative SLD programming. As the acquired TV programming is a digitized into video data stream, PIP ads (or value-added content) data is relatively easily inserted. That programming is then multicast 530 through the network to the customer premise, and to a STB 240. STB 240 is configured, for example, to receive and play 540 the SLD programming on a subscriber's television device. In addition, the STB 240 may be configured to block access to the normal programming corresponding to the SLD programming. In another embodiment, all network or advertising-based programming accessed by a subscriber is SLD programming.

In addition, a premium service may be provide value-added content/services using IP-based techniques. These value-added services may be provided during normal ad and normal program time using space-based-differentiation techniques. All these services may be customized based on each subscriber's different requirements. The value added service content can be displayed, for example, in the small PIP windows as shown in FIGS. 4A, 4B and 4C. The value-added services can include instant messenger, voice mail, caller Id, email, etc. Or, for example when broadcasting a sports program, the small PIP window may be used to show more detailed (for example enlarged) pictures or a replay window under the subscriber's control.

As shown in FIG. 6, this premium service may be provided according to the example embodiment of method 600, wherein normal programming is acquired 610, and further wherein the programming includes time-based advertising inserted for example by a national or local provider in the broadcast network. The normal programming is then combined 620 with value-added services, using server 325, to provide an alternative SLD programming. That programming is then multicast 630 through the network to the customer premise, and to a STB 240. STB 240 is configured, for example, to receive and play 640 the SLD programming on a subscriber's television device. In addition, the STB 240 may be configured to block access to the normal programming corresponding to the SLD programming. In another embodiment, all network or advertising-based programming accessed by a subscriber is SLD programming.

In another embodiment, a subscriber may be profiled by analyzing the subscriber's content service levels and most frequently viewed ads and TV programs. Subscribers may be categorized based on their profiles. Typical categories may include, but are not limited to, sports, action, western, and eastern, etc. Using these categories, the system may deliver to the subscribers in a particular category commercials that are of high interest. For example, if a household subscribes to the premium service level, it is more likely the subscriber will prefer more high-end products. If a subscriber often views sports programs, the subscriber may be more likely to purchase related sporting goods. Subscriber profiling/categorizing can then be combined with time-based-differentiation and/or space-based-differentiation to delivery targeted ads to intended subscribers. Such profiling and categorization may be recorded in subscriber database system 350, which may provide information to SLD server 225 to enable creation of service level differentiated services as described herein

Referring to FIG. 7, this subscriber group service may be provided according to the example embodiment of method 700, wherein normal programming is acquired 710. The normal programming is then combined 720 with time or space-based advertising, using server 325, to provide an alternative SLD programming that is targeted at one or more customer groups or categories. That programming is then multicast 730 through the network to the customer premise, and to a STB 240. STB 240 is configured, for example, to receive and play 740 the targeted SLD programming on a subscriber's television device. In addition, the STB 240 may be configured to receive only the SLD programming.

Accordingly, in yet another example embodiment, by manipulating the time and content (ads or value-added), an IPTV system can provide different service levels to both subscribers (providing different service levels) and TV advertisers (by varying the time length of ads as well as the number and group of ads viewers).

Referring now to FIG. 8, there is illustrated an alternate embodiment of the inventive subject matter hereof. In the architecture and method 800 of FIG. 8, service level differentiated (SLD) programming is acquired 810, multicast to the STBs 240, such that the STB 240s receives live television programming from the acquisition servers 320 or the video distribution servers 330, and creates service level differentiated variants of one or more channels of the programming to provide SLD channels to the respective subscriber. In accordance with an alternate embodiment, the normal channel and the advertising or value-added service can be delivered via separate channels and combined together at the STB 240.

Thus, as described above, the systems and methods described herein provide service providers more flexibility to provide IPTV advertisement services and value-added content, attract different levels of subscribers, and potentially increase the penetration ratio of IPTV services. The system can further facilitate more effective delivery of advertisements to target subscribers, assisting advertisers to achieve more effective use of advertising resources.

Further, in accordance with various embodiments of the inventive subject matter hereof, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the inventive subject matter hereof as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives may be considered a distribution medium equivalent to a tangible storage medium. Accordingly, the invention may be considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention may be not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

Although the inventive subject matter has been described with reference to several example embodiments, it may be understood that the words that have been used are words of description and illustration, rather than words of limitation. Changes may be made within the purview of the appended claims, as presently stated and as amended, without departing from the scope and spirit of the inventive subject matter in all its aspects. Although the inventive subject matter has been described with reference to particular means, materials and embodiments, the inventive subject matter is not intended to be limited to the particulars disclosed; rather, the subject matter extends to all functionally equivalent structures, methods, and uses such as are within the scope of the appended claims.

What is claimed is:

1. A method comprising:
acquiring first television programming, wherein the first television programming includes time-based advertising;
combining the programming with space-based advertising used to create service level differentiated programming; and
multicasting the service level differentiated programming in an Internet Protocol data stream through a network to a customer premise.

2. A method according to claim 1 further including receiving the service level differentiated programming at a set top box located at the customer premise and producing a television signal based on the service level differentiated programming.

3. A method according to claim 1 further wherein the set top box may be configured to display the service level differentiated programming and not the first television programming if the first television programming is also received at the set top box.

4. A method according to claim 3 further wherein the space based content is using a picture in a picture format.

5. A method comprising:
acquiring first television programming, wherein the first television programming includes time-based advertising;
combining the programming with space-based value-added content used to create service level differentiated programming; and
multicasting the service level differentiated programming in an Internet Protocol data stream through a network to a customer premise.

6. A method according to claim 5 further including receiving the service level differentiated programming at a set top box located at the customer premise and producing a television signal based on the service level differentiated programming.

7. A method according to claim 5 further wherein the set top box may be configured to display the service level differentiated programming and not the first television programming if the first television programming is also received at the set top box.

8. A method according to claim 5 further wherein the space-based content is displayed using a picture-in-a-picture format.

9. A method comprising:
acquiring first television programming, wherein the first television programming includes time-based advertising;
combining the programming with alternate content to create service level differentiated programming;
multicasting the service level differentiated programming in an Internet Protocol data stream through a network to a plurality of customer premises; and
wherein the service level differentiated programming is received and viewed by subscribers that have been grouped together at least in part for the purpose of receiving a particular stream of service level differentiated programming.

10. A method according to claim 9 further including receiving the service level differentiated programming at a set top box located at the customer premise and producing a television signal based on the service level differentiated programming.

11. A method according to claim 9 further wherein the set top box may be configured to display the service level differentiated programming and not the first television programming if the first television programming is also received at the set top box.

12. A method according to claim 12 further wherein the space-based content is displayed using a picture-in-a-picture format.

13. A method comprising:
acquiring first television programming, wherein the first television programming includes time-based advertising;
multicasting the first television programming in an Internet Protocol data stream through a network to a customer premise; and
combining the first television programming with space-based advertising at the customer premise to create service level differentiated programming.

14. A method according to claim 13 further including receiving the service level differentiated programming at a set top box located at the customer premise and producing a television signal based on the service level differentiated programming.

15. A method according to claim 13 further wherein the set top box may be configured to display the service level differentiated programming.

16. A method according to claim 13 further wherein the space based content is using a picture in a picture format.
